(19) United States
(12) Patent Application Publication
(10) Pub. No.: US 2022/0042313 A1
(43) Pub. Date: Feb. 10, 2022

(54) Roofing Sample Display

(71) Applicant: Brilliant Graphics Group, LLC, Pittsfield, MA (US)

(72) Inventor: Michael Ryan, Pittsfield, MA (US)

(21) Appl. No.: 17/396,250

(22) Filed: Aug. 6, 2021

Related U.S. Application Data
(60) Provisional application No. 63/062,157, filed on Aug. 6, 2020.

(51) Int. Cl. E04D 1/26; E04D 1/34

(52) U.S. Cl. CPC E04D 1/26; E04D 2001/3435; E04D 1/34

(57) ABSTRACT

A roofing sample display having a plurality of panels or sections that fold over one another. The roofing sample display has a top primary panel having printed matter on both an inner and an outer side of the panel, a bottom primary panel having a plurality of layers of shingle samples attached to an inner side with a rubber pressure-sensitive adhesive and printed matter on an outer side, a secondary internal panel having printed matter on both an inner and an outer side, and two thin end panels to accommodate the thickness of the plurality of layers of shingle samples and thereby allow the roofing sample board to fold neatly.

### CROSS-REFERENCE TO RELATED APPLICATIONS

The present application claims the benefit of the filing date of U.S. Provisional Patent Application Ser. No. 63/062,157 filed by the present inventors on Aug. 6, 2020.

The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

### Field of the Invention

The present invention relates to roofing sample displays.

### Brief Description of the Related Art

A variety of roofing sample display boards have been used in the roofing industry. Examples of such a roofing sample display board can be seen in U.S. Design Pat. No. D624969, which shows a roofing sample board with a combination of roofing samples and high-definition printing on a portion of a single roofing sample board.

### SUMMARY OF THE INVENTION

In a preferred embodiment, the present invention is a roofing sample display comprising a plurality of connected panels that fold over one another. The plurality of panels comprise a top primary panel having printed matter on both an inner and an outer side, a bottom primary panel having a plurality of layers of shingle samples attached to an inner side with a hot-melt rubber pressure-sensitive adhesive and printed matter on an outer side, a secondary internal panel having printed matter on both an inner and an outer side, and a first end panel connecting the top primary panel to the bottom primary panel. A second end panel connects the bottom primary panel to the secondary internal panel. The second end panel accommodates a thickness of the plurality of layers of shingle samples attached to the bottom primary panel and thereby allows the secondary internal panel to fold over and the bottom primary panel. The first end panel accommodates the thickness of the plurality of layers of shingle samples attached to the bottom primary panel and a thickness of the secondary internal panel and thereby allows the top primary panel to fold over the secondary internal panel and substantially parallel to the bottom primary panel. The hot-melt rubber-based pressure-sensitive adhesive may have a specific gravity between 0.95-1.05, viscosity of 20,000-25,000 at 275°, a viscosity of 9,100-13,000 cps at 300°, a viscosity of 5,400-7,400 cps at 325° and a viscosity of 3,600-5,100 cps at 350°. The shingle samples may be attached to all or only a portion of the inner side of the bottom primary panel and any remainder of the inner side of the bottom primary panel is covered with printed matter.

In another preferred embodiment, the present invention is a roofing sample display having a flat base having a length, width and thickness, wherein the length and width of the flat base are at least 100 times the thickness of the flat base. The flat base comprises a first flat panel having printed matter on both an inner side and an outer side, a second flat panel having a first edge connected to an edge of the first flat panel, a third flat panel having a first edge connected to a second edge of the second flat panel, the third flat panel having printed matter on an outer side, a fourth flat panel having a first edge connected to a second edge of the third flat panel, and a fifth flat panel having a first edge connected to a second edge of the fourth flat panel, the fifth flat panel having printed matter on both. A plurality of layers of shingle samples are attached to an inner side of the third flat panel with a rubber pressure-sensitive adhesive and printed matter on an outer side. The first flat panel and the third flat panel are of the same size and shape. The first, second, third, fourth and fifth panels may be formed from a single base flat material by a plurality of transverse folds across the flat base.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature and not as restrictive. Additional objects and advantages of the invention will be set forth in part in the description which follows and in part will be obvious from the description or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a top perspective view of the closed roofing material display in accordance with a preferred embodiment of the present invention.

FIG. 2A is a front view of the closed roofing material display in accordance with a preferred embodiment of the present invention with printed matter.

FIG. 2B is a front view of the closed roofing material display in accordance with a preferred embodiment of the present invention with printed matter.

FIG. 3A is a rear view of the closed roofing material display in accordance with a preferred embodiment of the present invention without printed matter.

FIG. 3B is a rear view of the closed roofing material display in accordance with a preferred embodiment of the present invention with printed matter with identification of locations of printed matter.

FIG. 4 is a left side view of the closed roofing material display in accordance with a preferred embodiment of the present invention.

FIG. 5 is a right side view of the closed roofing material display in accordance with a preferred embodiment of the present invention.

FIG. 6 is a top view of the closed roofing material display in accordance with a preferred embodiment of the present invention.

FIG. 7 is a bottom view of the closed roofing material display in accordance with a preferred embodiment of the present invention.

FIG. 8 is a top perspective view of the open roofing material display in accordance with a preferred embodiment of the present invention;

FIG. 9 is a close-up right side view of a plurality of roofing samples on an open roofing material display in accordance with a preferred embodiment of the present invention.

FIG. 10A is a front view of the open roofing material display in accordance with a preferred embodiment of the present invention without printed matter.

FIG. 10B is a front view of the open roofing material display in accordance with a preferred embodiment of the present invention with printed matter.

FIG. 11A is a rear view of the open roofing material display in accordance with a preferred embodiment of the present invention without printed matter.

FIG. 11B is a rear view of the open roofing material display in accordance with a preferred embodiment of the present invention with printed matter.

FIG. 12 is a left side view of the open roofing material display in accordance with a preferred embodiment of the present invention.

FIG. 13 is a right side view of the open roofing material display in accordance with a preferred embodiment of the present invention.

FIG. 14 is a top view of the open roofing material display in accordance with a preferred embodiment of the present invention.

FIG. 15 is a bottom view of the open roofing material display in accordance with a preferred embodiment of the present invention.

FIG. 16 is a perspective view illustrating how a roofing material display in accordance with a preferred embodiment of the present invention is folded into a closed position and unfolded into an open position.

### DETAILED DESCRIPTION OF THE PREFERRED EMBODIMENTS

A preferred embodiment of the present invention is described with reference to the figures. A roofing sample display 100 in accordance with the present invention has a flat base having a plurality of fold lines running transversely across the base to form a plurality of panels or sections that fold over one another. In a preferred embodiment the base is 72 point white chip board with the fold lines being made by conventional cutting/folding equipment. The base material alternatively may be any paper-based material such as paperboard that is rigid yet foldable. Further the base material can be composed of any suitable material such as thermoplastic resins such as polyethylene, polypropylene, polyvinyl acetatepolyvinyl copolymers, or the like. Still further, the base may be formed of a plurality of separate rigid panels that are connected together by some means such as tape such that the seems form the fold lines for the roofing sample display.

The plurality of panels created by the fold lines include a top primary panel 200 having printed matter 212, 214, 216 on an outer side 210 and printed matter 222, 224 on an inner side 220 of the top primary panel 200, a bottom primary panel 400 having a plurality of layers of shingle samples 900 attached to an inner side 420 and printed matter 412, 414, 416 on an outer side 410, a secondary internal panel 600 having printed matter 622, 612, 614 on both an inner side 620 and an outer side 610, and two thin end panels 300, 500 to accommodate the thickness of the plurality of layers of shingle samples and thereby allow the roofing sample board to fold neatly.

The plurality of layers of roofing samples include a first layer 910 covering only a portion of the inside 420 of the bottom primary panel 400, a second layer 920 overlaying the first layer 910 and covering an additional portion of the inside 420 of the bottom primary panel 400, a third layer overlaying at least 60% of the second layer 920, a fourth layer 940 overlaying the third layer, a fifth layer 950 overlaying a portion of the fourth layer that extends beyond an edge of the first layer 910, and a sixth layer 960 overlaying the fifth layer 950. Each of the plurality of layers 910, 920, 930, 940, 950, 960 may comprise samples of one or a plurality of the same or different roofing shingles.

The plurality of layers of roofing samples are secured to the inside 420 of the bottom primary panel 400 with a hot melt rubber-based pressure-sensitive adhesive having specific gravity between 0.95-1.05, viscosity of 20,000-25,000 at 275°, a viscosity of 9,100-13,000 cps at 300°, a viscosity of 5,400-7,400 cps at 325° and a viscosity of 3,600-5,100 cps at 350°.

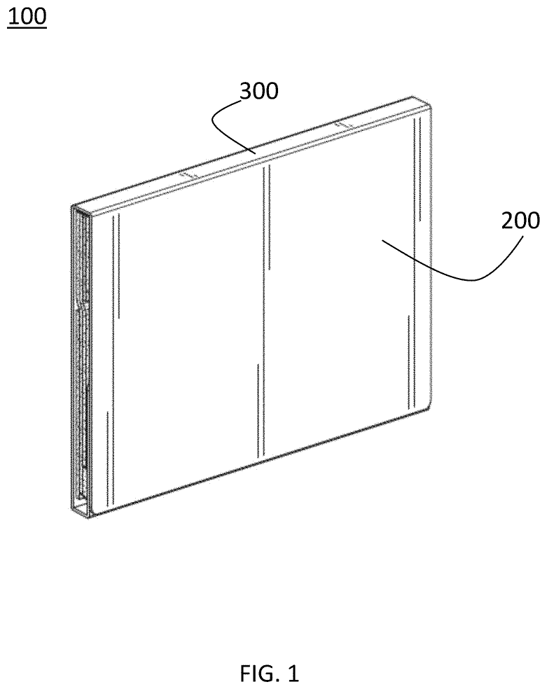

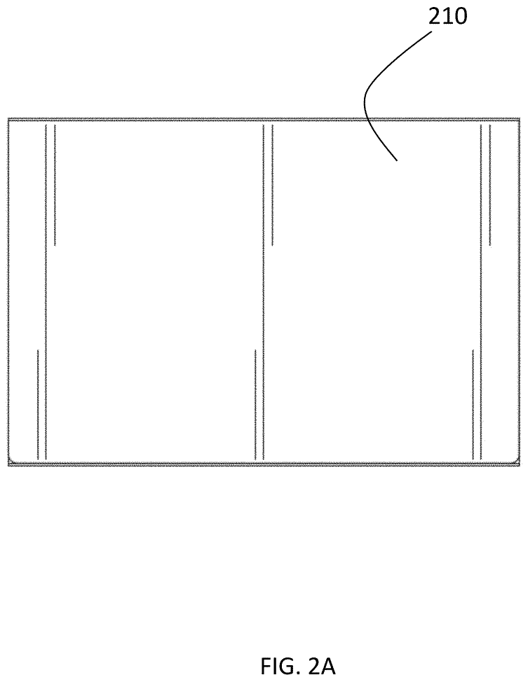

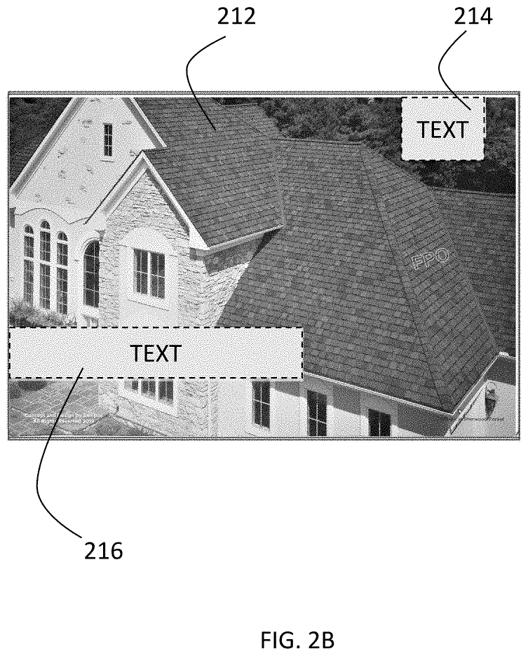

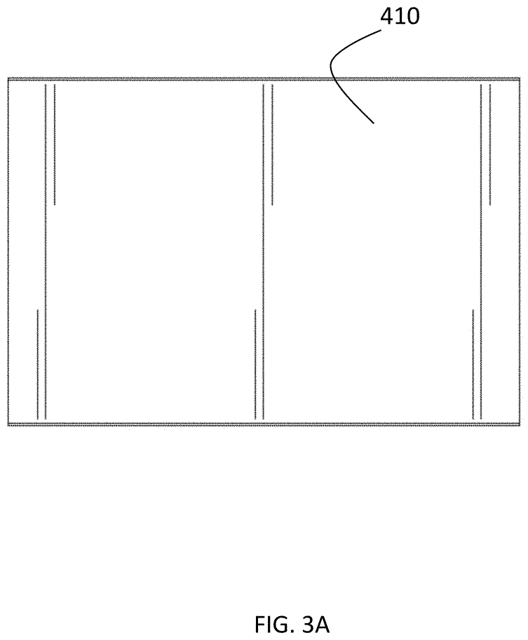

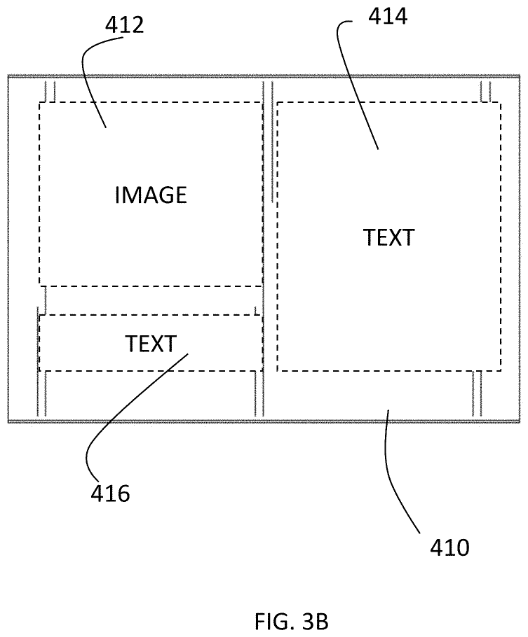

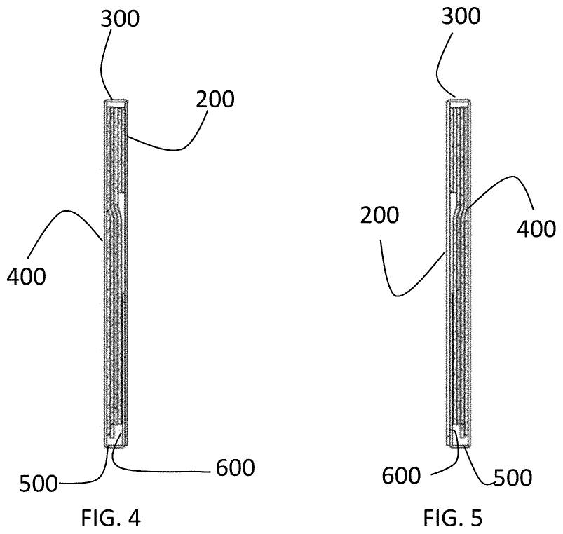

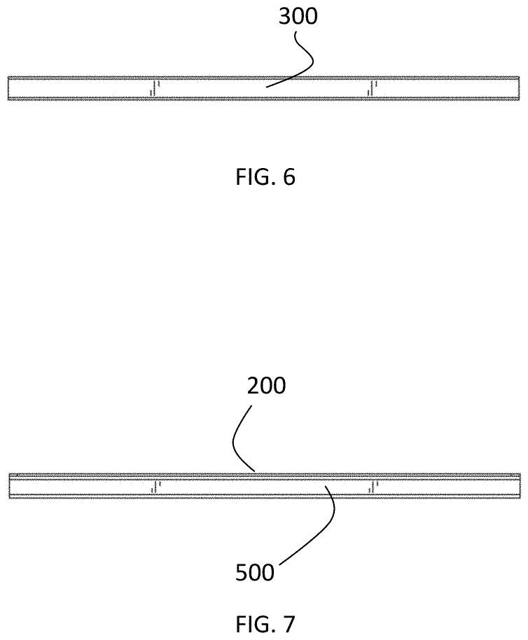

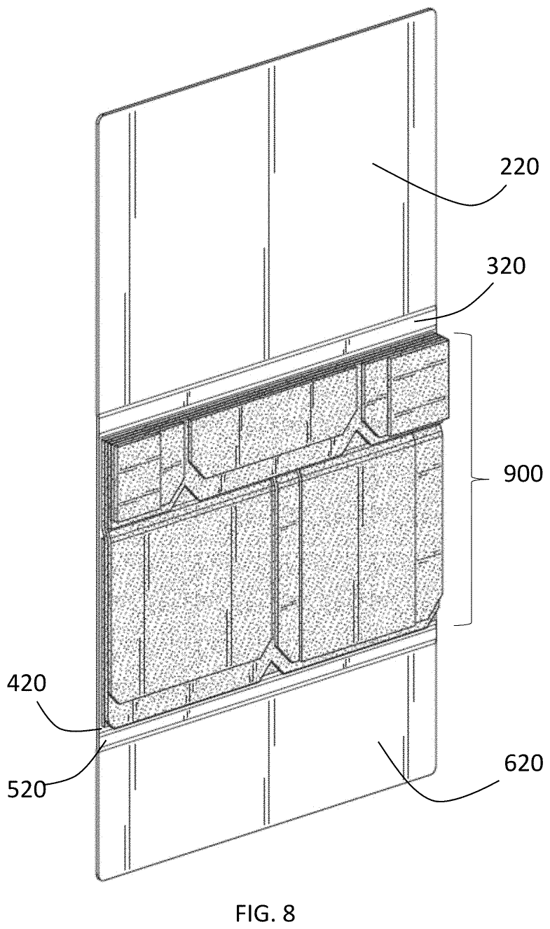

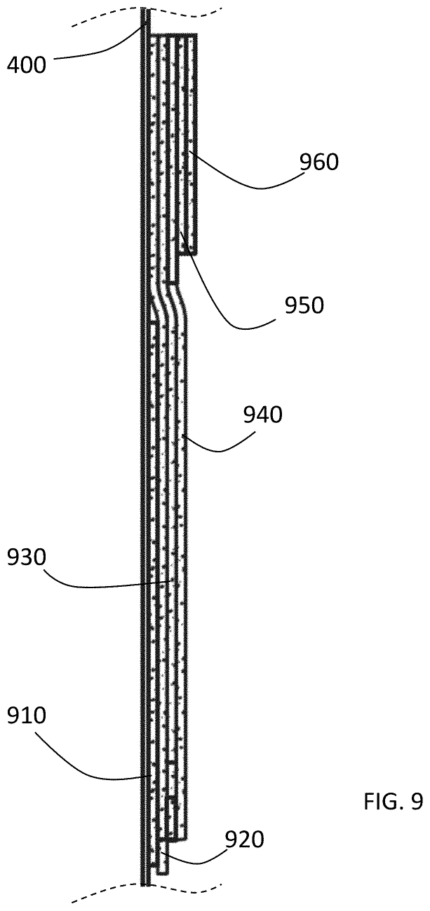

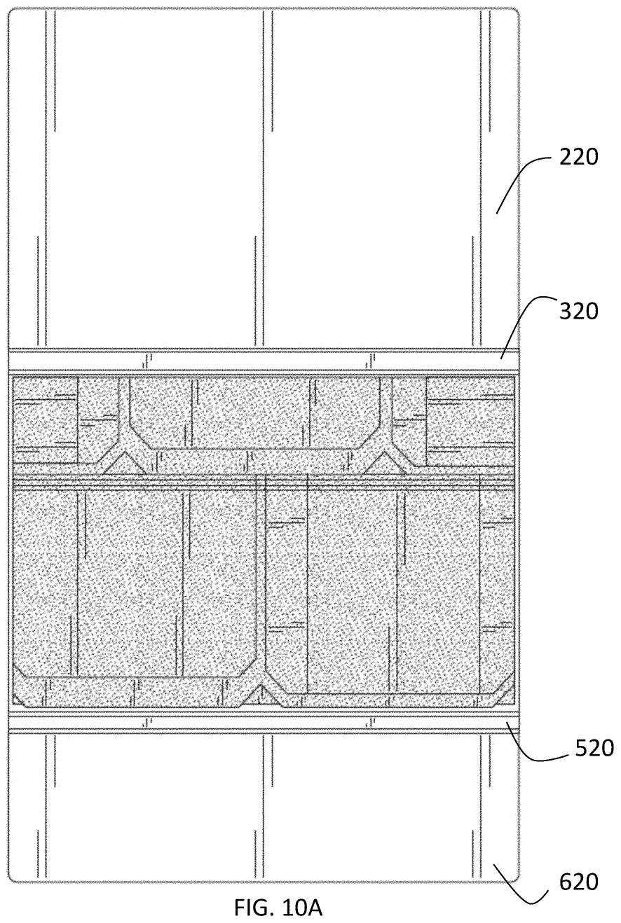

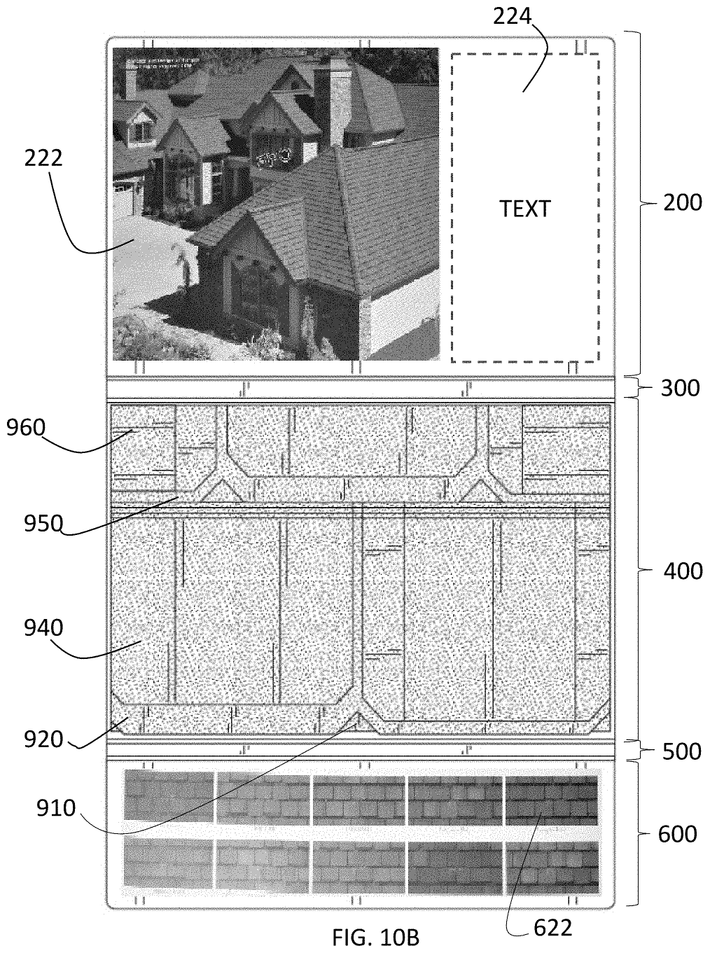

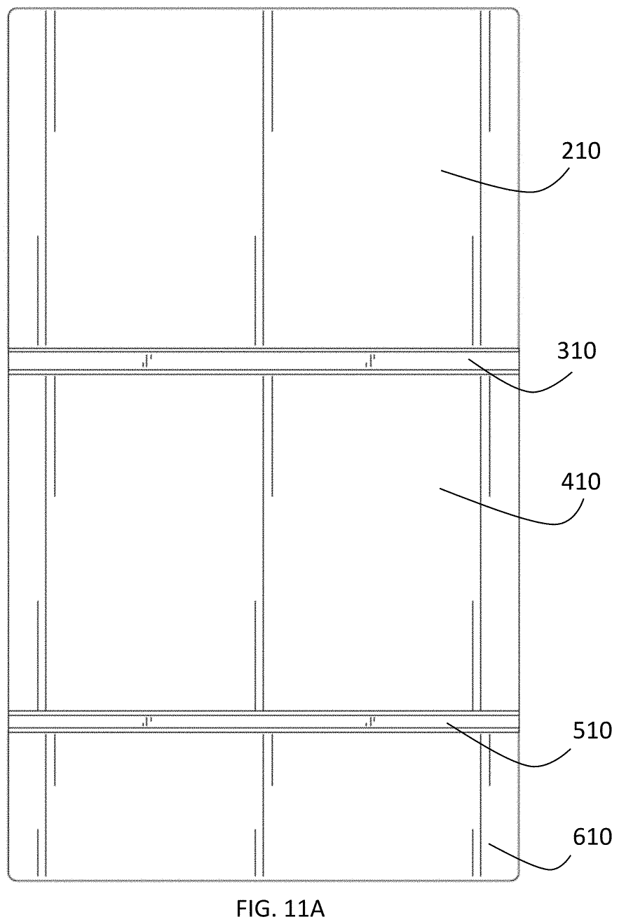

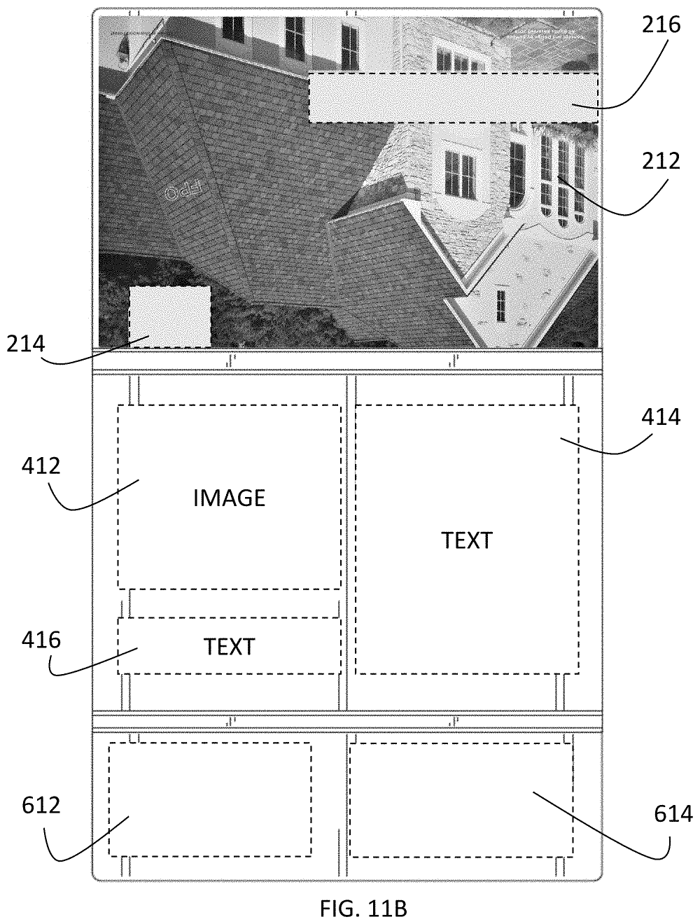

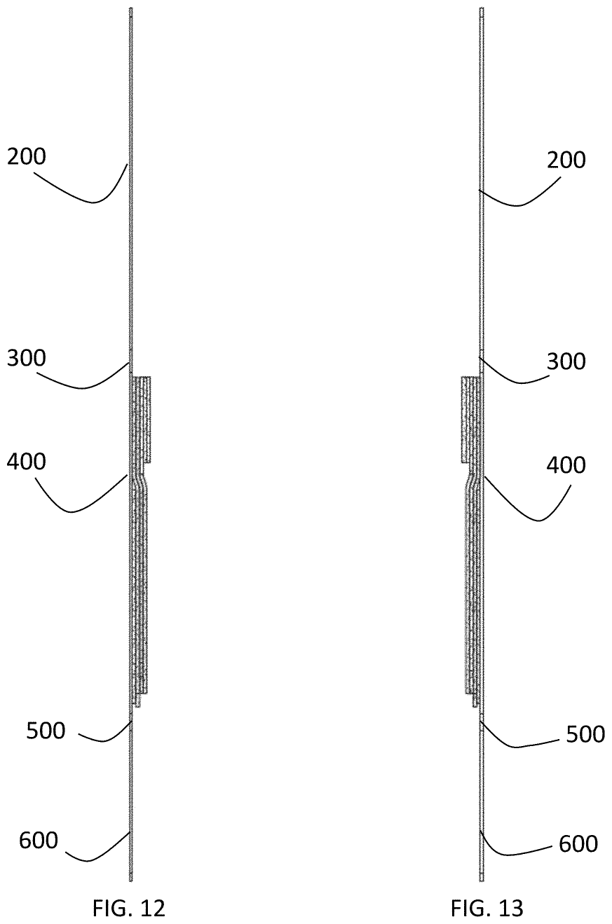

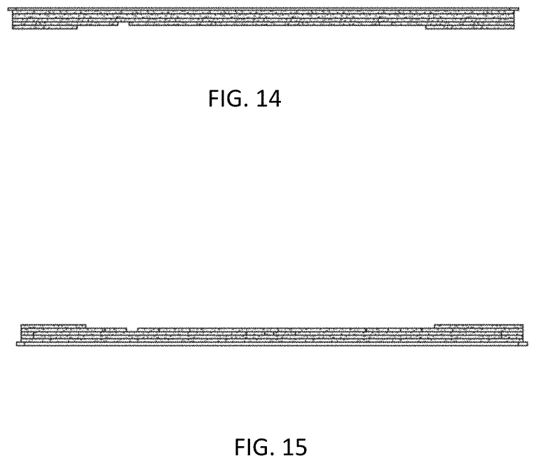

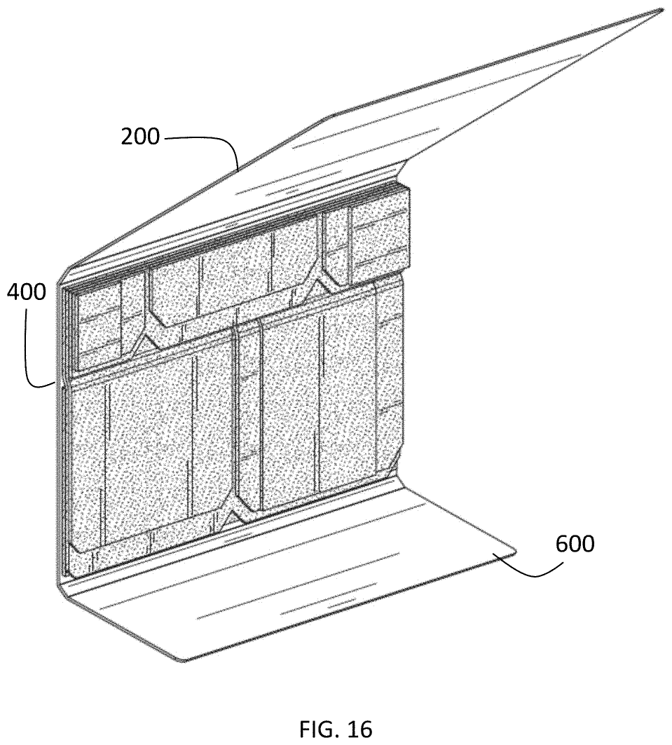

As shown in FIGS. 1-7, a roofing sample display according to the present invention can be folded into a form convenient for transportation in which the roofing samples are protected inside the folded display. Printed material can be placed on all outer sides of the folded roofing sample display to allow for maximum conveyance of information and advertising.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto and their equivalents. The entirety of each of the aforementioned documents is incorporated by reference herein.

What is claimed is:

1. A roofing sample display comprising a plurality of connected panels that fold over one another, wherein the plurality of panels comprise:
a top primary panel having printed matter on both an inner and an outer side;
a bottom primary panel having a plurality of layers of shingle samples attached to an inner side with a hot-melt rubber pressure-sensitive adhesive and printed matter on an outer side;
a secondary internal panel having printed matter on both an inner and an outer side; and
a first end panel connecting said top primary panel to said bottom primary panel; and
a second end panel connecting said bottom primary panel to said secondary internal panel;
wherein second end panel accommodates a thickness of the plurality of layers of shingle samples attached to the bottom primary panel and thereby allows the secondary internal panel to fold over and the bottom primary panel; and
wherein the first end panel accommodates said thickness of the plurality of layers of shingle samples attached to the bottom primary panel and a thickness of the secondary internal panel and thereby allows the top primary panel to fold over said secondary internal panel and substantially parallel to the bottom primary panel.

2. A roofing sample display according to claim 1 wherein said hot-melt rubber-based pressure-sensitive adhesive has a specific gravity between 0.95-1.05, viscosity of 20,000-25,000 at 275°, a viscosity of 9,100-13,000 cps at 300°, a viscosity of 5,400-7,400 cps at 325° and a viscosity of 3,600-5,100 cps at 350°.

3. A roofing sample display according to claim 1 wherein said shingle samples are attached to only a portion of said inner side of said bottom primary panel and any remainder of said inner side of said bottom primary panel is covered with printed matter.

4. A roofing sample display comprising:
a flat base having a length, width and thickness, wherein said length and width of said flat base are at least 100 times said thickness of said flat base, said flat base comprising:
a first flat panel having printed matter on both an inner side and an outer side;
a second flat panel having a first edge connected to an edge of said first flat panel;
a third flat panel having a first edge connected to a second edge of said second flat panel, said third flat panel having printed matter on an outer side;
a fourth flat panel having a first edge connected to a second edge of said third flat panel; and
a fifth flat panel having a first edge connected to a second edge of said fourth flat panel, said fifth flat panel having printed matter on both;
a plurality of layers of shingle samples attached to an inner side of said third flat panel with a rubber pressure-sensitive adhesive and printed matter on an outer side;

5. A roofing sample display according to claim 1, wherein said first flat panel and said third flat panel are of the same size and shape.

6. A roofing panel according to claim 1, wherein said first, second, third, fourth and fifth panels are formed by a plurality of transverse folds across said flat base.
